(19) United States
(12) Patent Application Publication
(10) Pub. No.: US 2015/0257956 A1
(43) Pub. Date: Sep. 17, 2015

(54) Toilet Seat

(71) Applicant: Joseph Wang, Kaohsiung City (TW)

(72) Inventor: Joseph Wang, Kaohsiung City (TW)

(21) Appl. No.: 14/205,533

(22) Filed: Mar. 12, 2014

(51) Int. Cl. A61G 7/10

(52) U.S. Cl. CPC A61G 7/1007; A61G 2200/34

(57) ABSTRACT

A toilet seat includes a fixing member having a first engagement portion and a first pivotal portion. The first engagement is mounted to a toilet bowl. A first seat includes a second pivotal portion and a third pivotal portion respectively on two ends of the first seat. The second pivotal portion is pivotably connected to the first pivotal portion of the fixing member. A second seat includes a fourth pivotal portion pivotably connected to the third pivotal portion of the first seat. A lifting device is connected to the first seat and the second seat. The lifting device is coupled to a controller. The controller is operable to actuate the lifting device to increase or reduce a spacing between the first seat and the second seat.

### BACKGROUND OF THE INVENTION

1. Field of the Invention

The present invention relates to a toilet seat and, more particularly, to a toilet seat using a hydraulic or pneumatic telescopic cylinder to assist a user to stand up from the toilet seat.

2. Description of the Related Art

Toilets are a necessary sanitary device in daily lives of modern people. Compared to traditional squat toilets, flush toilets avoid the user from tiredness and discomfort resulting from keeping the squat position for a long period of time. Thus, flush toilets have wider applications. However, the toilet seat of a flush toilet is substantially horizontal and causes inconvenience to the user standing up after use. Particularly, a person with mobility problems, such as an aged man, pregnant woman, disabled person, or a patient suffering from lower limb diseases, stands up difficultly and could slip, drop down, or fall from the toilet.

FIG. 1 shows a conventional toilet seat 8 for fixing the above disadvantage. The toilet seat 8 includes a pivotal end 81 pivotably connected to a toilet bowl 80 and a movable end 82 opposite to the pivotal end 81. The toilet seat 8 includes an inclined upper surface at an angle to a horizontal plane. The toilet seat 8 has decreasing thicknesses from the pivotal end 81 toward the movable end 82 to assist a user to stand up from the toilet bowl 80. An example of such a toilet seat 8 is disclosed in Taiwan Utility Model No. M440750.

However, the toilet seat 8 merely relies on the inclined upper surface 83 to assist the user to stand up, and the angle between the inclined upper surface 83 and the horizontal plane is in a range between 15° and 23° for providing the user with comport during use, which provides limited assistance to a person with server mobility problems.

In view of this disadvantage, FIG. 2 shows another conventional toilet seat 9 including a motor 91, a gear transmission unit 92, a support arm 93, and a seat 94. The motor 91 and the gear transmission unit 92 are mounted to a toilet 90. The gear transmission unit 92 is connected to the motor 91 and the support arm 93. The support arm 93 is connected to the seat 94. The support arm 93 is in the form of a rack. When the motor 91 rotates in a direction, the support arm 93 moves toward the seat 94 via transmission by the gear transmission unit 92. The rear end of the seat 94 is lifted to an inclined position assisting the user to stand up. On the other hand, when the motor 91 rotates in the reverse direction, the support arm 93 moves downwardly via transmission by the gear transmission unit 92, lowering the seat 94 to a horizontal position. An example of such a toilet seat 9 is disclosed in Taiwan Patent Publication No. 219480.

However, since the toilet 90 is usually mounted in a humid space, such as a rest room or a bathroom, the service life of the motor 91 is apt to be shortened by the moisture. Furthermore, since the seat 94 has to withstand the weight of the user, the motor 91 is generally a low-speed high-torque motor. The gear transmission unit 92 consisting of gears and the support arm 93 in the form of a rack are apt to wear during use under the action of the weight of the user exerted to the seat 94 and the output torque of the motor 91. In severe conditions, the support arm 93 disengages from the gear transmission unit 92, shorting the service life of the toilet seat 9.

Either the motor 91 is damaged or the gear transmission unit 92 and the support arm 93 wear, the user can not do the maintenance work due to the complicated structure and difficulties in acquiring the parts. Thus, the user must hire a professional to repair or directly replace the toilet seat 9, resulting in high maintenance costs and maintenance inconvenience. Furthermore, when the seat 94 is lowered to the horizontal position, the support arm 93 extends outside of the bowl of the toilet 90 such that the whole toilet 90 occupies a considerable space, causing difficulties in installation while causing use inconvenience.

Thus, in view of the disadvantages of short service life and use inconvenience in the conventional toilet seat 9 using the motor 91 to move the seat 94 via transmission by the gear transmission unit 92 and the support arm 93, a need exists for an improved toilet seat for assisting the user to stand up to increase the market value and the market share.

### SUMMARY OF THE INVENTION

An objective of the present invention is to provide a toilet seat using a lifting device to connect a first seat and a second seat. The second seat is pivotably connected to the first seat. The lifting device can be actuated to increase or reduce a spacing between first and second ends of the lifting device. The second seat can be lifted to assist the user to stand up from the toilet seat, prolonging the service life of the toilet seat.

Another objective of the present invention is to provide a toilet seat using a telescopic cylinder or a screw rod transmission assembly as a power source to move the second seat, replacing the motor, gear transmission unit, and support arm used in the conventional toilet seat. The overall volume of the toilet seat can be reduced to increase use convenience of the toilet seat.

The present invention fulfills the above objectives by providing a toilet seat including a fixing member having a first engagement portion and a first pivotal portion. The first engagement is adapted to be mounted to a toilet bowl. A first seat includes a second pivotal portion and a third pivotal portion respectively on two ends of the first seat. The second pivotal portion is pivotably connected to the first pivotal portion of the fixing member. A second seat includes a fourth pivotal portion pivotably connected to the third pivotal portion of the first seat. A lifting device is connected to the first seat and the second seat. The lifting device is coupled to a controller. The controller is operable to actuate the lifting device to increase or reduce a spacing between the first seat and the second seat.

Preferably, the toilet bowl includes a second engagement portion that is an engaging mechanism corresponding to the first engagement portion of the fixing member. The first engaging member is adapted to align and engage with the second engagement portion.

Preferably, the first engagement portion includes a plurality of through-holes. The second engagement portion includes a plurality of fixing holes. The plurality of through-holes of the first engagement portion is adapted to align with the plurality of fixing holes of the second engagement portion. A plurality of fasteners extends through the plurality of through-holes and the plurality of fixing holes to fix the fixing member to the toilet bowl.

In an example, the lifting device is a telescopic cylinder. The lifting device has a first end and a second end. The first end of the lifting device is connected to the first seat. The second end of the lifting device is connected to the second seat. The controller is operable to control the lifting device to extend or retract.

Preferably, the first end of the lifting device is connected to the first seat at a location between the second pivotal portion and the third pivotal portion, with a spacing between the first end of the lifting device and the second pivotal portion smaller than a spacing between the first end of the lifting device and the third pivotal portion. Preferably, the second end of the lifting device is connected to the second seat at a location between the second pivotal portion and the fourth pivotal portion, with a spacing between the second end of the lifting device and the second pivotal portion smaller than a spacing between the second end of the lifting device and the fourth pivotal portion.

In an example, the first seat includes an extension extending away from the second seat, and the first end of the lifting device is connected to the extension.

Preferably, the second seat includes a guiding portion located between the second pivotal portion and the fourth pivotal portion, with a spacing between the guiding portion and the second pivotal portion smaller than a spacing between the guiding portion and the fourth pivotal portion. The second end of the lifting device is engaged in the guiding portion.

In an example, the guiding portion is a groove extending along a periphery of the second seat, and the second end of the lifting device is slideably received in the groove.

In another example, the lifting device includes a screw rod transmission assembly having a screw rod and a link. The screw rod is fixed to the first seat and has a threaded portion. The link includes an end in threading connection with the threaded portion. The link further includes another end connected to the second seat. The controller is coupled to the screw rod and is operable to drive the screw rod to rotate.

Preferably, the lifting device includes a screw rod transmission assembly having a screw rod and a link. The screw rod is fixed to the first seat and has a threaded portion. The link includes a screw sleeve in threading connection with the threaded portion of the screw rod. The connecting rod further includes an end pivotably connected to the screw sleeve, as well as another end connected to the second seat.

Preferably, the screw rod of the lifting device is mounted to the first seat at a location between the second pivotal portion and the third pivotal portion, with a spacing between the screw rod and the second pivotal portion smaller than a spacing between the screw rod and the third pivotal portion. Preferably, the second end of the link is connected to the second seat at a location between the second pivotal portion and the fourth pivotal portion, with a spacing between the second end of the link and the second pivotal portion smaller than a spacing between the second end of the link and the fourth pivotal portion.

Preferably, the lifting device further includes a guiding rod. The guiding rod has a base, a first end, and a second end. The base is rotatably connected to the screw rod. The first end of the guiding rod is pivotably connected to the base. The second end of the guiding rod is connected to the second seat. An intermediate portion of the link between the first and second ends of the link is pivotably connected to an intermediate portion of the guiding portion between the first and second ends of the guiding rod.

Preferably, the second seat includes two guiding portions respectively engaged with the second end of the link and the second end of the guiding rod. Each guiding portion is located between the second pivotal portion and the fourth pivotal portion, with a spacing between each guiding portion and the second pivotal portion smaller than a spacing between each guiding portion and the fourth pivotal portion.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 is a perspective view of a toilet using a conventional toilet seat.

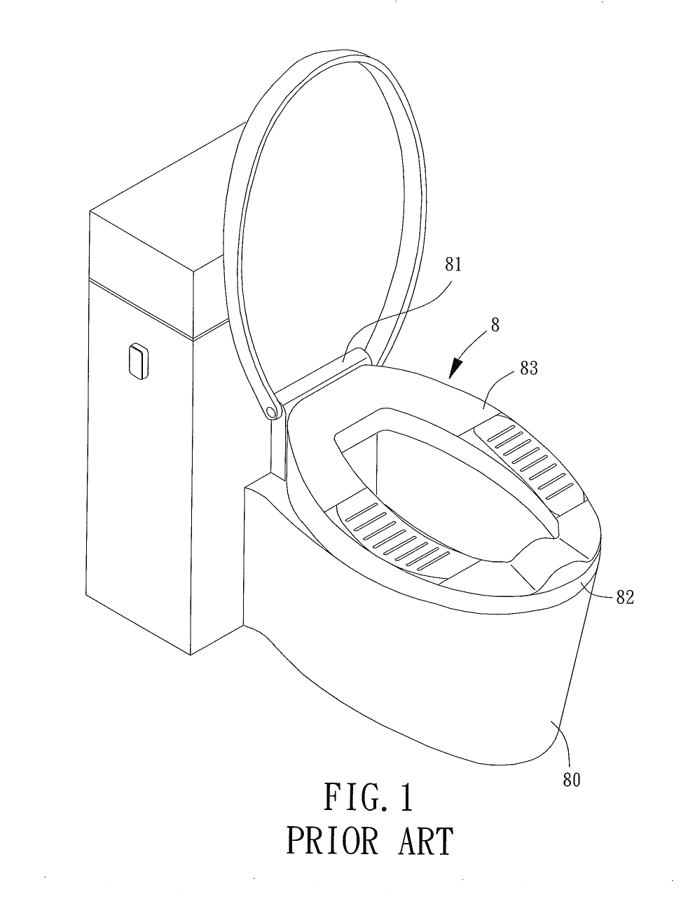

FIG. 2 is a side view of a toilet using another conventional toilet seat, with a portion of the toilet cross sectioned.

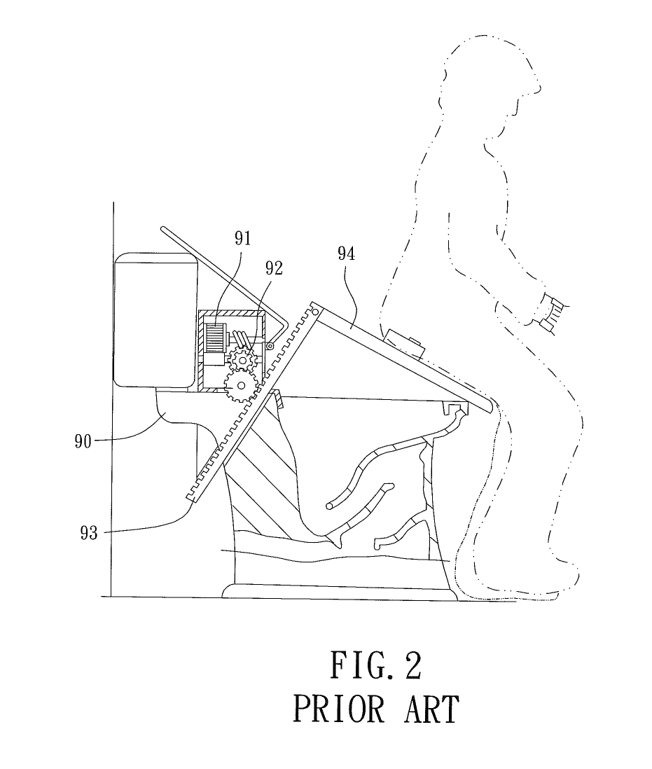

FIG. 3 is an exploded, perspective view of a toilet using a toilet seat of a first embodiment according to the present invention.

FIG. 4 is an exploded, perspective view of the toilet seat of FIG. 3.

FIG. 5 is a partial side view of the toilet seat of FIG. 3, with a second seat of the toilet seat in a lower position.

FIG. 6 is a view similar to FIG. 5, with the second seat in an elevated inclined position.

FIG. 7 is an exploded, perspective view of a toilet seat of a second embodiment according to the present invention.

FIG. 8 is a partial cross sectional view of the toilet seat of FIG. 7 after assembly, with a second seat of the toilet seat in a lower position.

FIG. 9 is a partial view of the toilet seat of FIG. 7, with the second seat in an elevated position.

FIG. 10 is a view similar to FIG. 8, with the second seat in the elevated position.

FIG. 11 is a view similar to FIG. 9, with the second seat lowered.

### DETAILED DESCRIPTION OF THE INVENTION

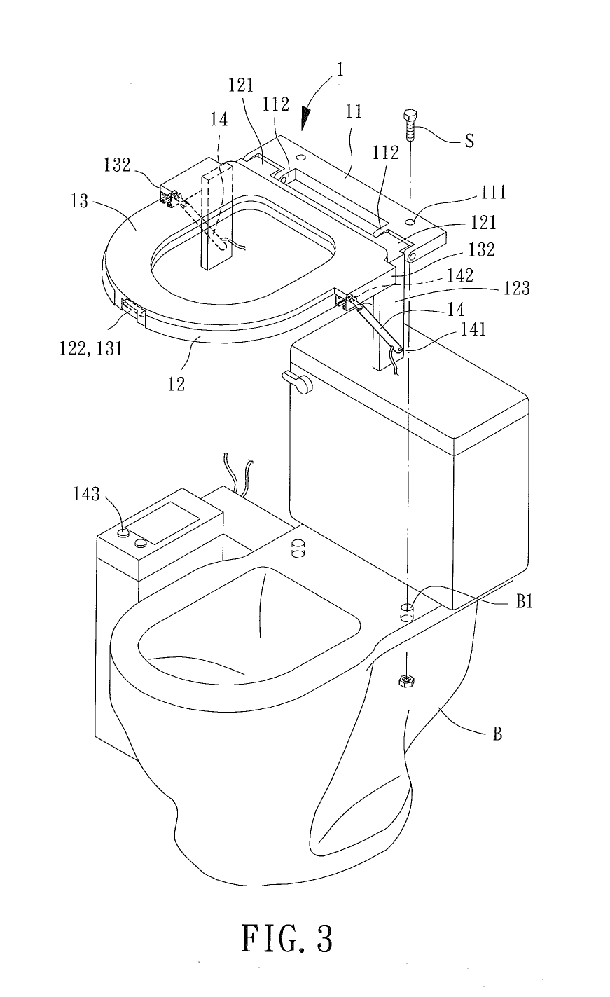

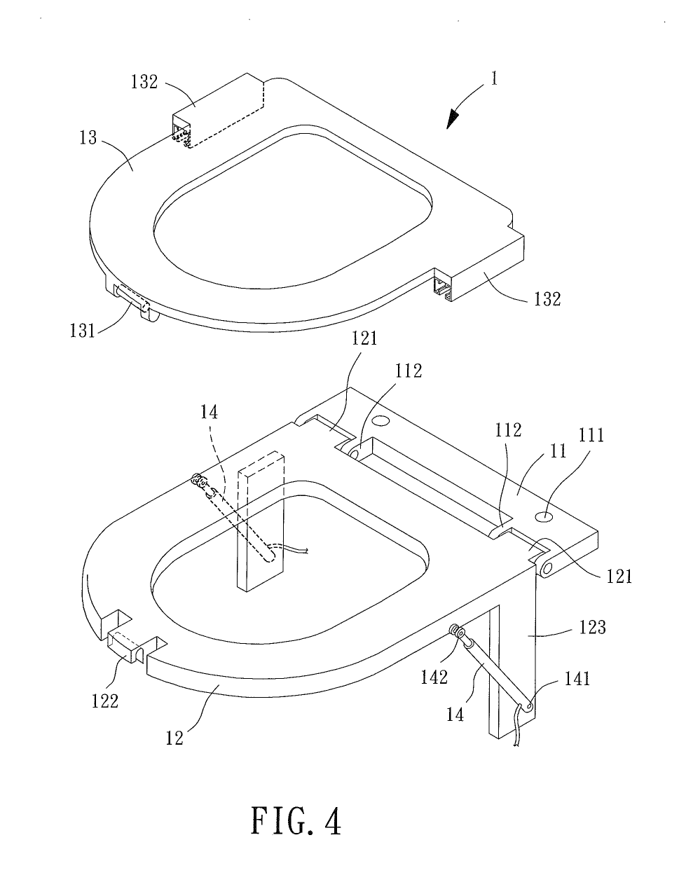

With reference to FIGS. 3 and 4, a toilet seat 1 of a first embodiment according to the present invention includes a fixing member 11, a first seat 12, a second seat 13, and a lifting device 14. The first seat 12 is connected to the fixing member 11 and the second seat 13. The lifting device 14 is connected to the first seat 12 and the second seat 13. The toilet seat 1 is adapted to be mounted on a toilet bowl B. The toilet bowl B can be of a conventional type.

The fixing member 11 includes a first engagement portion 111. The toilet bowl B includes a second engagement portion B1. The second engagement portion B1 is an engaging mechanism corresponding to the first engagement portion 111. The first engaging member 111 is adapted to align and engage with the second engagement portion B1 such that the fixing member 11 is detachably fixed to the toilet bowl B. In this embodiment, the first engagement portion 111 of the fixing member 11 includes a plurality of through-holes. The second engagement portion B1 of the toilet bowl B includes a plurality of fixing holes. The through-holes of the first engagement portion 111 are adapted to align with the fixing holes of the second engagement portion B1. Fasteners S, such as screws, extend through the through-holes and the fixing holes to reliably fix the fixing member 11 to the toilet bowl B. Nevertheless, in addition to the fastener engagement, mortise and tenon coupling, snapping mechanism, or threading coupling can be used for the first and second engagement portions 111 and B1. The fixing member 11 further includes a first pivotal portion 112.

The first seat 12 includes a second pivotal portion 121 and a third pivotal portion 122 respectively on two ends of the first seat 12. The second pivotal portion 121 is pivotably connected to the first pivotal portion 112 of the fixing member 11, allowing the first seat 12 to pivot relative to the fixing member 11.

The second seat 13 includes a fourth pivotal portion 131 pivotably connected to the third pivotal portion 122 of the first seat 12, allowing the second seat 13 to pivot relative to the first seat 12.

In this embodiment, the lifting device 14 includes two telescopic cylinders. However, the lifting device 14 can include only one telescopic cylinder, such as a hydraulic or pneumatic telescopic cylinder. Description will be made by way of example of a single telescopic cylinder. Preferably, the lifting device 14 is a hydraulic telescopic cylinder to provide a sufficient weight-withstanding capacity. The lifting device 14 includes a first end 141 and a second end 142. Furthermore, the lifting device 14 is coupled to a controller 143 that can be operated to actuate the lifting device 14 to increase or reduce a spacing between the first seat 12 and the second seat 13. The first end 141 of the lifting device 14 is connected to the first seat 12. The second end 142 of the lifting device 14 is connected to the second seat 13. When the spacing between the first end 141 and the second end 142 of the lifting device 14 is increased or reduced by control of the controller 43, the spacing between the first seat 12 and the second seat 13 is increased or reduced accordingly.

Specifically, due to pivotal connection between the fourth pivotal portion 131 of the second seat 13 and the third pivotal portion 122 of the first seat 12, the second seat 13 is pivotable relative to the first seat 12 about a pivoting axis defined by the third and fourth pivotal portions 122 and 131. Thus, the first end 141 of the lifting device 14 is preferably connected to an end of the first seat 12 adjacent to the second pivotal portion 121 (i.e., the end of the first seat 12 is distant to the third pivotal portion 122). Namely, the first end 141 of the lifting device 14 is connected to the first seat 12 at a location between the second pivotal portion 121 and the third pivotal portion 122, with a spacing between the first end 141 of the lifting device 14 and the second pivotal portion 121 smaller than a spacing between the first end 141 of the lifting device 14 and the third pivotal portion 122.

Furthermore, the second end 142 of the lifting device 14 is preferably connected to an end of the second seat 13 distant to the fourth pivotal portion 131. Namely, the second end 142 of the lifting device 14 is connected to the second seat 13 at a location between the second pivotal portion 121 and the fourth pivotal portion 131, with a spacing between the second end 142 of the lifting device 14 and the second pivotal portion 121 smaller than a spacing between the second end 142 of the lifting device 14 and the fourth pivotal portion 131. Thus, the lifting device 14 is distant to the third and fourth pivotal portions 122 and 131. By such an arrangement, when the spacing between the first end 141 and the second end 142 is increased under operation of the controller 143, the lifting device 14 serves as a force application point to drive the second seat 13 to pivot about the pivot axis defined by the third and fourth pivotal portions 122 and 131, thereby lifting the second seat 13.

On the other hand, when the spacing between the first end 141 and the second end 142 is reduced under operation of the controller 143, the second seat 13 is preferably lowered to a position abutting the first seat 12. Since the first end 141 and the second end 142 are respectively connected to the first seat 12 and the second seat 13, the length of the lifting device 14 is shorter if the second seat 13 abuts the first seat 12, causing limitation to the telescopic travel. Thus, the first seat 12 preferably includes an extension 123. The extension 123 can be located adjacent to the second pivotal portion 121 and extend away from the second seat 13. The first end 141 of the lifting device 14 is connected to the extension 123 such that the lifting device 14 still has a sufficient length avoiding limitation to the telescopic travel even though the second seat 13 abuts the first seat 12.

Furthermore, the second seat 13 can include a guiding portion 132. The guiding portion 132 is preferably located on the end of the second seat 13 distant to the fourth pivotal portion 131. Namely, the guiding portion 132 is located between the second pivotal portion 121 and the fourth pivotal portion 131, with a spacing between the guiding portion 132 and the second pivotal portion 121 smaller than a spacing between the guiding portion 132 and the fourth pivotal portion 131. The guiding portion 132 can be a guiding structure such as a groove, track, or pivot for engagement with the second end 142 of the lifting device 14. In this embodiment, the guiding portion 132 is a groove extending along a periphery of the second seat 13, and the second end 142 of the lifting device 14 is slideably received in the groove. By such an arrangement, when the spacing between the first end 141 and the second end 142 is increased to lift the second seat 13 under operation of the controller 143, the second end 142 can slide in the guiding portion 132 to reduce the stress imparted from the lifting device 14 to the second seat 13, avoiding breakage of the second seat 13 resulting from excessive pressure at the connection between the second seat 13 and the lifting device 14.

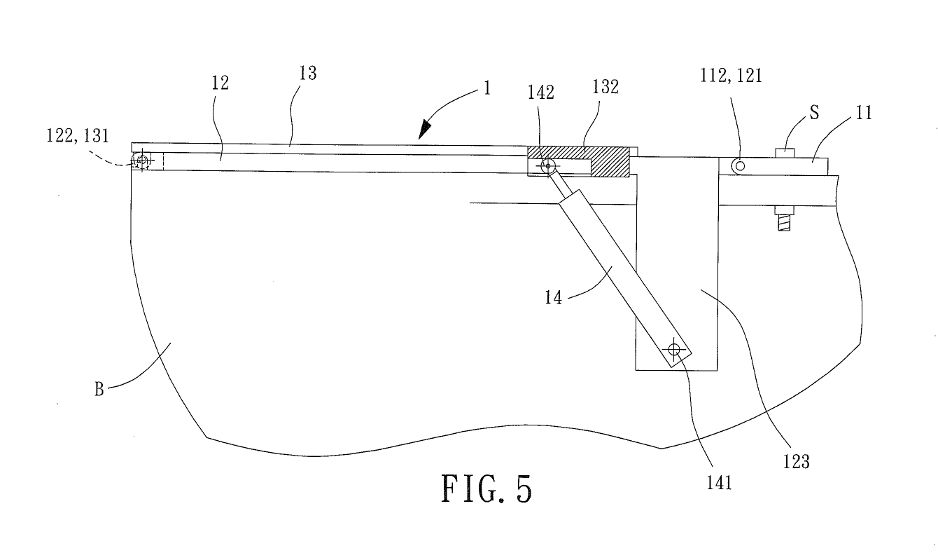

With reference to FIG. 5, in use of the toilet seat 1 of this embodiment, the toilet seat 1 can be fixed by the fixing member 11 to a toilet bowl B, with the first seat 12 located between the second seat 13 and the toilet bowl B. Since the first engagement portion 111 of the fixing member 11 is aligned and engages with the second engagement portion B1 of the toilet bowl B, the fixing member 11 can be detachably mounted to the toilet bowl B. Thus, a user can mount the toilet seat 1 to toilets of any suitable type.

The first seat 12 is pivotably connected to the fixing member 11, and the second seat 13 is connected to the first seat 12. Thus, the first and second seats 12 and 13 can pivot jointly relative to the fixing member 11 about a pivot axis defined by the first and second pivotal portions 112 and 121 and, thus, can be lifted to a predetermined position allowing use by a male or allowing cleaning of the toilet bowl B. When the user sits on the toilet seat 1, the first seat 12 abuts the toilet bowl B, and the second seat 13 preferably abuts the first seat 12, reliably supporting the weight of the user.

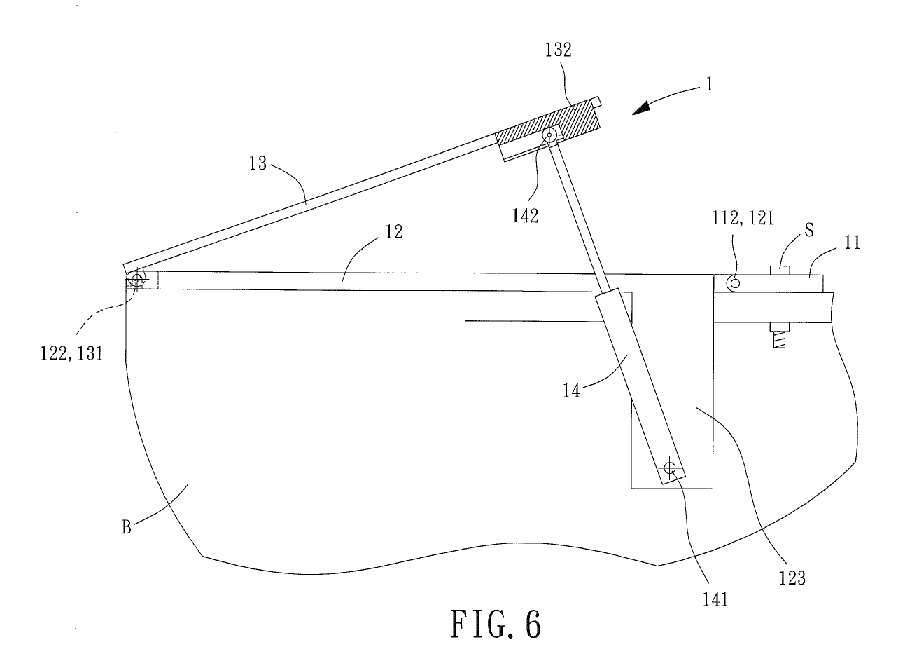

With reference to FIG. 6, when the user is intended to stand up after using the toilet, the controller 143 can be operated to extend the lifting device 14, increasing the spacing between the first end 141 and the second end 142 of the lifting device 14. Thus, the lifting device 14 serves as a force application point to drive the second seat 13 to pivot about the pivot axis defined by the third and fourth pivotal portions 122 and 131 relative to the first seat 12, lifting the second seat 13. Thus, the spacing between the first seat 12 and the second seat 13 is increased such that the second seat 13 is in an inclined position relative to the horizontal plane, assisting the user to stand up from the toilet seat 1.

On the other hand, if the user is intended to sit onto the toilet seat 1, the controller 143 can be operated to lift the second seat 13 via the lifting device 14, lifting the second seat 13 to the inclined position assisting the user to sit onto the toilet seat 1. Then, the controller 143 can be operated to retract the lifting device 14 to move the second seat 13 to abut the first seat 12, providing the user with use convenience.

By the above structure, the toilet seat 1 of the first embodiment according to the present invention uses the telescopic rod as a lifting device 14 whose first and second ends 141 and 142 are respectively connected to the first seat 12 and the second seat 13 pivotably connected to the first seat 12. Furthermore, the lifting device 14 is coupled to a controller 143 capable of actuating the lifting device 14 to extend or retract by using fluid pressure. Thus, the spacing between the first end 141 and the second end 142 is increased or reduced to lift or lower the second seat 13, assisting the user to stand up from or sit down onto the toilet seat 1.

Compared to the conventional toilet seat 9 using the motor 91 as the power source for actuating the seat 94 and using the gear transmission unit 92 and the support arm 93 as a transmission mechanism, the toilet seat 1 of this embodiment according to the present invention uses the lifting device 14 as the power source for actuating the second seat 13, wherein the lifting device 14 is a hydraulic or pneumatic telescopic cylinder which can more effectively avoid moisture in comparison with motor 91. Thus, the service life of the lifting device 14 is not shortened even if the toilet seat 1 is mounted in a humid place such as a restroom or bathroom. Furthermore, connection of the first and second ends 141 and 142 with the first and second seats 12 and 13 allows the second seat 13 to be directly actuated by the lifting device 14 without any transmission mechanism like the gear transmission unit 92 and the support arm 93. Accordingly, compared to the conventional toilet seat 9 having a shorter service life due to wear or disengagement of the gear transmission unit 92 and the support arm 93, the toilet seat 1 according to the present invention surely has a prolonged service life.

Furthermore, using a telescopic cylinder as the lifting device 14 provides advantages of low malfunction rate and easy maintenance. Furthermore, the volume of the lifting device 14 in the retracted state is small. Compared to the conventional toilet seat 9 having a large overall volume due to the fact that the support arm 93 extend outside of the toilet bowl of the toilet 90 when the seat 94 is lowered to the horizontal position, the toilet seat 1 of this embodiment according to the present invention using the lifting device 14 as the power source for actuating the second seat 13 can effectively reduce the overall volume of the toilet seat 1, allowing easy installation while providing enhanced use convenience.

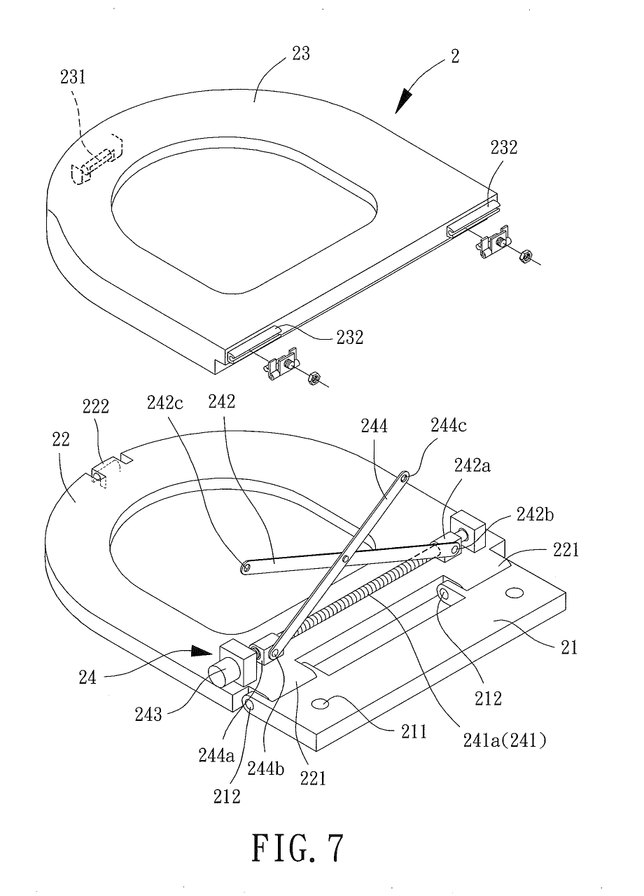

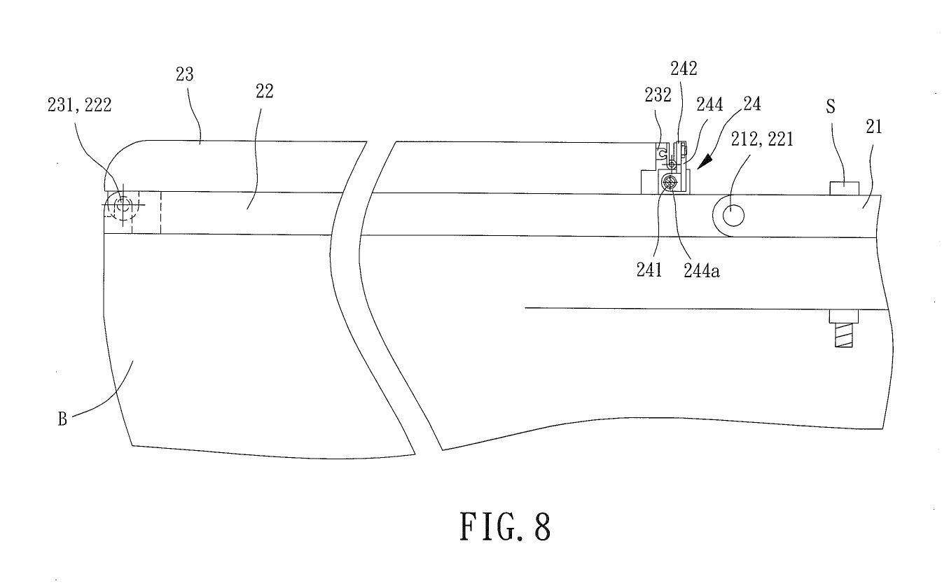

With reference to FIGS. 7 and 8, a toilet seat 2 of a second embodiment according to the present invention also includes a fixing member 21, a first seat 22, a second seat 23, and a lifting device 24. The lifting device 24 is also connected to the first seat 22 and the second seat 23. The difference between the second embodiment and the first embodiment is that the lifting device 24 is a screw rod transmission assembly including a screw rod 241 and a link 242. The screw rod 241 is fixed to the first seat 22 and has a threaded portion 241a. The link 242 includes a screw sleeve 242a, a first end 242b, and a second end 242c. The screw sleeve 242a is in threading connection with the threaded portion 241a of the screw rod 241. The first end 242b of the link 242 is pivotably connected to the screw sleeve 242a. The second end 242c of the link 242 is connected to the second seat 23. The controller 243 can be a motor and preferably a step motor. The controller 243 is coupled to the screw rod 241 for driving the screw rod 241 to rotate, displacing the screw sleeve 242a of the link 242 along the screw rod 241. By such an arrangement, the first end 242b of the link 242 also displaces when the screw sleeve 242a displaces, such that the second end 242c of the link 242 actuates the second seat 23 to increase or reduce the spacing between the first seat 22 and the second seat 23.

Specifically, the screw rod 241 of the lifting device 24 is mounted to an end of the first seat 22 adjacent to the second pivotal portion 221, and the second end 242c of the link 242 is connected to an end of the second seat 23 distant to the fourth pivotal portion 231, such that the lifting device 24 is distant to the third pivotal portion 222 and the fourth pivotal portion 231. Namely, the screw rod 241 of the lifting device 24 is mounted to the first seat 22 at a location between the second pivotal portion 221 and the third pivotal portion 222, with a spacing between the screw rod 241 and the second pivotal portion 221 smaller than a spacing between the screw rod 241 and the third pivotal portion 222. Furthermore, the second end 242c of the link 242 is connected to the second seat 23 at a location between the second pivotal portion 221 and the fourth pivotal portion 231, with a spacing between the second end 242c of the link 242 and the second pivotal portion 221 smaller than a spacing between the second end 242c of the link 242 and the fourth pivotal portion 231.

Furthermore, the lifting device 24 can further include a guiding rod 244. The guiding rod 244 has a base 244a, a first end 244b, and a second end 244c. The base 244a is rotatably connected to a portion of the screw rod 241 other than the threaded portion 241a. The first end 244b of the guiding rod 244 is pivotably connected to the base 244a. The second end 244c of the guiding rod 244 is connected to the second seat 23. An intermediate portion of the link 242 between the first and second ends 242b and 242c of the link 242 is pivotably connected to an intermediate portion of the guiding portion 244 between the first and second ends 244b and 244c of the guiding rod 244.

Furthermore, the second seat 23 includes two guiding portions 232 on an edge of the second seat 23 distant to the fourth pivotal portion 231. Namely, each guiding portion 232 is located between the second pivotal portion 221 and the fourth pivotal portion 231, with a spacing between each guiding portion 232 and the second pivotal portion 221 smaller than a spacing between each guiding portion 232 and the fourth pivotal portion 231. The guiding portions 232 can be guiding structures such as grooves, tracks, or pivots for engagement with the second end 242c of the link 242 and the second end 244c of the guiding rod 244. By such an arrangement, when the first end 242b of the link 242 displaces along the screw rod 241, the link 242 pivots relative to the guiding rod 244 due to pivotal connection between the link 242 and the guiding rod 244. Thus, the second end 242c of the link 24 can lift or lower the second seat 13.

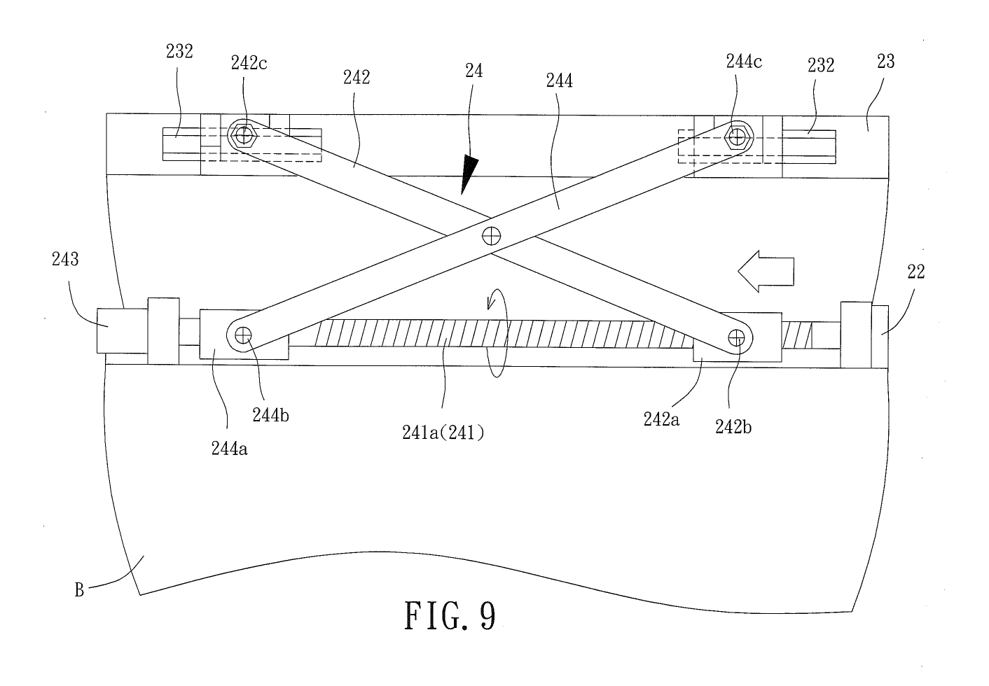

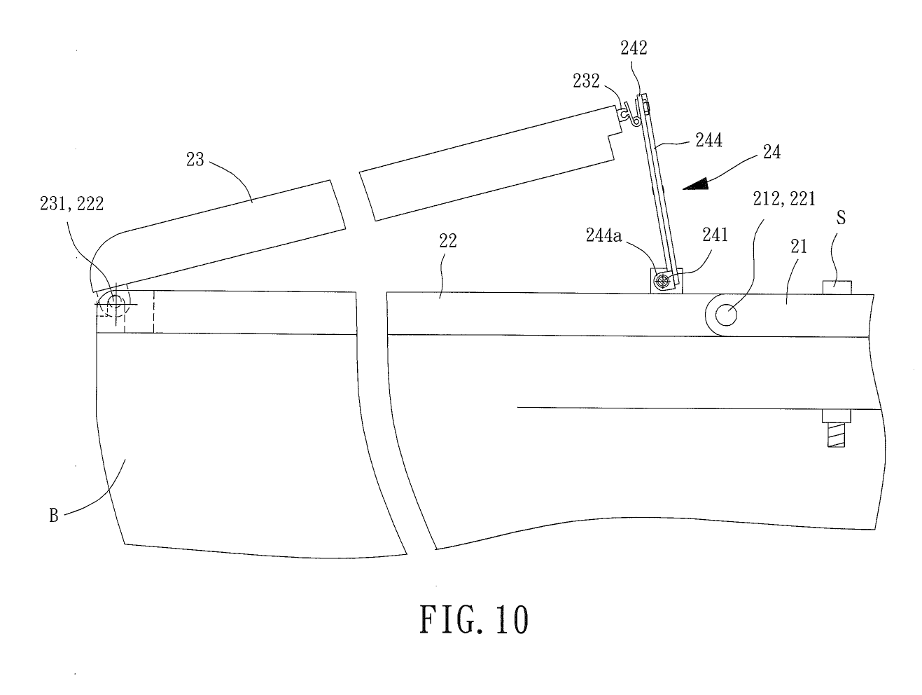

With reference to FIGS. 9 and 10, in this embodiment, when the controller 243 drives the screw rod 241 to rotate in a first direction such that the screw sleeve 242a of the link 242 moves along screw rod 241 towards the base 244a of the guiding rod 244, the first end 242b of the link 242 also moves along the screw rod 241 towards the first end 244b of the guiding rod 244. Thus, the link 242 pivots relative to the guiding rod 244 such that the second end 242c of the link 24 and the second end 244c of the guiding rod 244 can lift the second seat 23, increasing the spacing between the first seat 12 and the second seat 13.

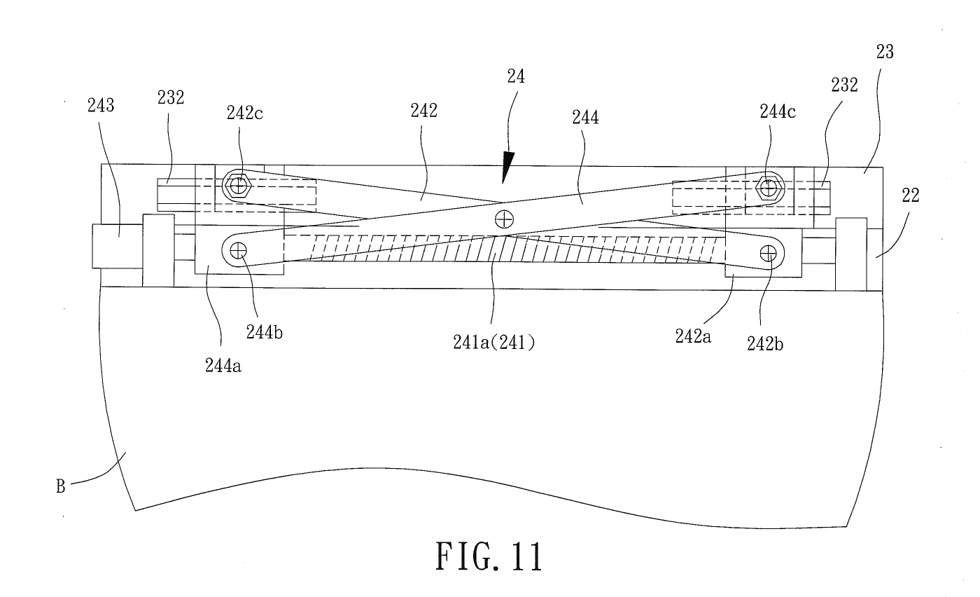

With reference to FIG. 11, on the other hand, when the controller 243 drives the screw rod 241 to rotate in a second direction opposite to the first direction such that the screw sleeve 242a of the link 242 moves along the screw rod 241 away from the base 244a of the guiding rod 244, the first end 242b of the link 242 also moves along the screw rod 241 away from the first end 2.44b of the guiding rod 244. Thus, the link 242 pivots relative to the guiding rod 244 such that the second end 242c of the link 24 and the second end 244c of the guiding rod 244 lower the second seat 23 to a position abutting the first seat 22.

By the above structure, the toilet seat 2 of the second embodiment according to the present invention uses a screw rod transmission assembly as a lifting device 24. The screw rod transmission assembly includes a screw rod 241 and a link 242. The screw rod 241 is mounted to a first seat 22 and includes a threaded portion 241a. An end of the link 242 is in threading connection with the threaded portion 241a. The other end of the link 242 is connected to a second seat 23. The screw rod 241 is coupled to a controller 243 that can be operated to drive the screw rod 241 to rotate, moving the screw sleeve 242a of the link 242 along the screw rod 241. The second end 242c of the link 242 actuates the second seat 23 to increase or reduce the spacing between the first seat 22 and the second seat 23, lifting or lowering the second seat 23 to assist the user to stand up from or sit down onto the toilet seat 2.

Compared to the conventional toilet seat 9 using the motor 91 as the power source for actuating the seat 94 and using the gear transmission unit 92 and the support arm 93 as a transmission mechanism, the toilet seat 2 of this embodiment according to the present invention uses the lifting device 24 as the power source for actuating the second seat 23, wherein the lifting device 24 is a screw rod transmission assembly connected to the first seat 22 and the second seat 23, and the screw rod 241 can be driven by the controller 243 to directly actuate the second seat 13 via the link 242 without any transmission mechanism like the gear transmission unit 92 and the support arm 93. Accordingly, compared to the conventional toilet seat 9 having a shorter service life due to wear or disengagement of the gear transmission unit 92 and the support arm 93, the toilet seat 2 according to the present invention surely has a prolonged service life because the screw rod transmission assembly evenly withstands stress, is less likely to wear, and is less likely to disengage.

Furthermore, using a screw rod transmission assembly as the lifting device 24 provides advantages of low malfunction rate and easy maintenance. Furthermore, the volume of the lifting device 24 in the retracted state is small, because the link 242 of the lifting device 24 can be received between the first seat 22 and the second seat 23. Compared to the conventional toilet seat 9 having a large overall volume due to the fact that the support arm 93 extend outside of the toilet bowl of the toilet 90 when the seat 94 is lowered to the horizontal position, the toilet seat 2 of this embodiment according to the present invention using the lifting device 24 as the power source for actuating the second seat 23 can effectively reduce the overall volume of the toilet seat 2, allowing easy installation while providing enhanced use convenience.

In view of the foregoing, the toilet seats 1 and 2 of the first and second embodiments according to the present invention prolong the service life of the toilet seats 1 and 2 while providing use convenience.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A toilet seat comprising:
a fixing member including a first engagement portion and a first pivotal portion, with the first engagement adapted to be mounted to a toilet bowl;
a first seat including a second pivotal portion and a third pivotal portion respectively on two ends of the first seat, and with the second pivotal portion pivotably connected to the first pivotal portion of the fixing member;
a second seat including a fourth pivotal portion, with the fourth pivotal portion pivotably connected to the third pivotal portion of the first seat; and
a lifting device connected to the first seat and the second seat, with the lifting device coupled to a controller, and with the controller operable to actuate the lifting device to increase or reduce a spacing between the first seat and the second seat.

2. The toilet seat as claimed in claim 1, with the toilet bowl including a second engagement portion, with the second engagement portion being an engaging mechanism corresponding to the first engagement portion of the fixing member, and with the first engaging member adapted to align and engage with the second engagement portion.

3. The toilet seat as claimed in claim 2, with the first engagement portion including a plurality of through-holes, with the second engagement portion including a plurality of fixing holes, with the plurality of through-holes of the first engagement portion adapted to align with the plurality of fixing holes of the second engagement portion, and with a plurality of fasteners extending through the plurality of through-holes and the plurality of fixing holes to fix the fixing member to the toilet bowl.

4. The toilet seat as claimed in claim 1, with the lifting device being a telescopic cylinder, with the lifting device having a first end and a second end, with the first end of the lifting device connected to the first seat, with the second end of the lifting device connected to the second seat, and with the controller operable to control the lifting device to extend or retract.

5. The toilet seat as claimed in claim 4, with the first end of the lifting device connected to the first seat at a location between the second pivotal portion and the third pivotal portion, with a spacing between the first end of the lifting device and the second pivotal portion smaller than a spacing between the first end of the lifting device and the third pivotal portion, with the second end of the lifting device connected to the second seat at a location between the second pivotal portion and the fourth pivotal portion, and with a spacing between the second end of the lifting device and the second pivotal portion smaller than a spacing between the second end of the lifting device and the fourth pivotal portion.

6. The toilet seat as claimed in claim 4, with the first seat including an extension extending away from the second seat, with the first end of the lifting device connected to the extension.

7. The toilet seat as claimed in claim 4, with the second seat including a guiding portion located between the second pivotal portion and the fourth pivotal portion, with a spacing between the guiding portion and the second pivotal portion smaller than a spacing between the guiding portion and the fourth pivotal portion, and with the second end of the lifting device engaged in the guiding portion.

8. The toilet seat as claimed in claim 7, with the guiding portion being a groove extending along a periphery of the second seat, with the second end of the lifting device slideably received in the groove.

9. The toilet seat as claimed in claim 1, with the lifting device including a screw rod transmission assembly having a screw rod and a link, with the screw rod fixed to the first seat and having a threaded portion, with the link including an end in threading connection with the threaded portion, with the link further including another end connected to the second seat, and with the controller coupled to the screw rod and operable to drive the screw rod to rotate.

10. The toilet seat as claimed in claim 1, with the lifting device including a screw rod transmission assembly having a screw rod and a link, with the screw rod fixed to the first seat and having a threaded portion, with the link including a screw sleeve in threading connection with the threaded portion of the screw rod, with the connecting rod further including an end pivotably connected to the screw sleeve, as well as another end connected to the second seat.

11. The toilet seat as claimed in claim 10, with the screw rod of the lifting device mounted to the first seat at a location between the second pivotal portion and the third pivotal portion, with a spacing between the screw rod and the second pivotal portion smaller than a spacing between the screw rod and the third pivotal portion, with the second end of the link connected to the second seat at a location between the second pivotal portion and the fourth pivotal portion, and with a spacing between the second end of the link and the second pivotal portion smaller than a spacing between the second end of the link and the fourth pivotal portion.

12. The toilet seat as claimed in claim 10, with the lifting device further including a guiding rod, with the guiding rod having a base, a first end and a second end, with the base rotatably connected to the screw rod, with the first end of the guiding rod pivotably connected to the base, with the second end of the guiding rod connected to the second seat, and with an intermediate portion of the link between the first and second ends of the link pivotably connected to an intermediate portion of the guiding portion between the first and second ends of the guiding rod.

13. The toilet seat as claimed in claim 12, with the second seat including two guiding portions respectively engaged with the second end of the link and the second end of the guiding rod, with each of the two guiding portions located between the second pivotal portion and the fourth pivotal portion, and with a spacing between each of the two guiding portions and the second pivotal portion smaller than a spacing between each of the two guiding portions and the fourth pivotal portion.
